(19) United States
(12) Patent Application Publication
(10) Pub. No.: US 2019/0358814 A1
(43) Pub. Date: Nov. 28, 2019

(54) ROBOT AND ROBOT SYSTEM COMPRISING SAME

(71) Applicant: LG ELECTRONICS INC., Seoul (KR)

(72) Inventors: Hyunwoong PARK, Seoul (KR); Haemin CHOI, Seoul (KR); Hyoungrock KIM, Seoul (KR); Jongjin WOO, Seoul (KR); Miyoung SIM, Seoul (KR)

(21) Appl. No.: 16/332,885

(22) PCT Filed: Aug. 29, 2017
(86) PCT No.: PCT/KR2017/009442

§ 371 Date: Mar. 13, 2019

(30) Foreign Application Priority Data
Sep. 13, 2016 (KR) 10-2016-0118227

(51) Int. Cl. B25J 9/16; G05D 1/02; B25J 13/08; B25J 13/00

(52) U.S. Cl. CPC B25J 9/1666; B25J 13/003; B25J 13/081; G05D 1/0291

(57) ABSTRACT

A robot according to an embodiment of the present invention provides a road guidance service and includes a driving driver configured to move the robot, a receiver configured to receive a road guidance request from a user, and a controller configured to set a path to a destination on basis of destination information included in the received road guidance request, generate guidance information including the set path, transmit the generated guidance information to each of other robots to communicate with the robot, and perform a road guidance operation corresponding to at least one path of the set path, and the at least one path is a path provided in the certain region where the robot is disposed.

### TECHNICAL FIELD

The present invention relates to an airport robot for providing a road guidance service in association with other airport robots and an airport robot system including the same.

### BACKGROUND ART

Recently, introduction of robots and the like is being discussed for more effectively providing various services to users at public places such as airport. Users may use various services such as a road guidance service, a boarding information guidance service, and other multimedia content providing services by using robots disposed at airport.

However, in high tech devices such as robots, the cost is inevitably high, and due to this, the number of airport robots disposed at airport may be limited. Therefore, a more efficient service providing method using a limited number of airport robots may be needed.

Particularly, in airport robots which provide a road guidance service at airport, a case where each of the airport robots provides the road guidance service while moving in all regions of airport may be inefficient. In a case where an airport robot disposed in a specific region leaves a corresponding region for a long time so as to perform the road guidance service up to an in-airport destination, other users located in the corresponding region may undergo inconvenience which should wait for a long time until the airport robot returns, for using the road guidance service. Also, when destinations are similar while airport robots are performing the road guidance service, a number of airport robots may concentrate on a specific region, and this may be inefficient in terms of providing an even service to users in several regions of airport.

### DISCLOSURE

### Technical Problem

A problem of the present invention is directed to providing an airport robot which is disposed in each of a plurality of regions of airport to perform road guidance in a corresponding region and an airport robot system including the same.

Another problem of the present invention is directed to providing an airport robot and an airport robot system including the same, in which a plurality of airport robots disposed at airport are prevented from concentrating on a specific region.

Another problem of the present invention is directed to implementing an airport robot and an airport robot system including the same, which may continually provide a road guidance service to a user in a case of providing the road guidance service by using a plurality of airport robots.

### Technical Solution

According to an aspect of the present invention for solving the object of the present invention, an airport robot according to an embodiment of the present invention may be disposed in one of a plurality of regions of airport to provide a road guidance service. When the airport robot receives a road guidance request from a user, the airport robot may set a path to a destination on the basis of destination information included in the received road guidance request. The airport robot may transmit guidance information including the set path to other airport robots disposed at the airport and may perform a road guidance operation on a first path, included in one region, of the set path.

According to another aspect of the present invention for solving the object of the present invention, an airport robot system according to an embodiment of the present invention includes a first airport robot disposed in a first region of a plurality of regions of airport and a second airport robot disposed in a second region adjacent to the first region. The first airport robot may set a path to a destination on the basis of the road guidance request received from a user. The first airport may perform a road guidance operation on a first path, included in the first region, of the set path, and the second airport robot may perform a road guidance operation on a second path, included in the second region, of the set path.

According to another aspect of the present invention for solving the object of the present invention, an airport robot according to an embodiment of the present invention may receive state information from other airport robots in the middle of performing a road guidance operation on a first path of a set path and may change the set path on the basis of the received state information.

According to another aspect of the present invention for solving the object of the present invention, an airport robot according to an embodiment of the present invention may receive state information, denoting that it is unable to provide a service, from an airport robot disposed in a region including a next path in the middle of performing a road guidance operation on a first path. Based on the received state information, the airport robot may generate road guidance information about the next path and may transmit the generated road guidance information to a mobile terminal of the user.

### Advantageous Effects

According to an embodiment of the present invention, each of airport robots may be disposed in one of a plurality of regions of airport and may perform a road guidance service in a disposed region. In a case where a path to a destination based on a road guidance request of a user is set in a plurality of regions, airport robots provide the road guidance service to the user by using a relay manner, thereby providing an effect where an efficient road guidance service is possible without deviating from a disposed region.

Moreover, in the middle of providing the road guidance service to a user, when a state of an airport robot disposed in a different region and thus it is unable to provide the road guidance service, a path may be fluidly changed or road guidance information about a path included in a corresponding region may be transmitted to a mobile terminal of a user. Accordingly, there is an effect where the road guidance service up to a destination may be provided continually.

### DESCRIPTION OF DRAWINGS

FIG. 1 is a diagram illustrating the structure of an airport robot system according to an embodiment of the present invention.

FIG. 2 is a block diagram illustrating a hardware configuration of an airport robot according to an embodiment of the present invention.

FIG. 3 is a diagram illustrating in detail a configuration of each of a microcomputer and an application processor (AP) of an airport robot according to another embodiment of the present invention.

FIG. 4 is a diagram illustrating an example where a plurality of airport robots according to an embodiment of the present invention are respectively disposed in a plurality of regions of airport to provide a service.

FIG. 5 is a ladder diagram for describing a road guidance service providing method of an airport robots according to an embodiment of the present invention.

FIG. 6 is a diagram for describing for describing an embodiment of an operation of setting, by an airport robot, a path to a destination.

FIG. 7 is a flowchart for describing another embodiment of an operation of setting, by an airport robot, a path to a destination.

FIG. 8 is an exemplary diagram of a path to a destination set according to an embodiment illustrated in FIG. 7.

FIG. 9 is a flowchart for describing for describing another embodiment of an operation of setting, by an airport robot, a path to a destination.

FIG. 10 is an exemplary diagram of a path to a destination set according to an embodiment illustrated in FIG. 9.

FIGS. 11A to 11D are diagrams illustrating an operation of guiding, by a plurality of airport robots according to an embodiment of the present invention, a user to a destination.

FIG. 12 is a flowchart for describing an operation of changing, by an airport robot according to an embodiment of the present invention, a path to a destination on the basis of a state of another airport robot.

FIG. 13 is a flowchart for describing an operation of providing, by an airport robot according to an embodiment of the present invention, road guidance information to a mobile terminal of a user when it is unable for an airport robot of a next region to provide a service.

### MODE FOR INVENTION

Hereinafter, embodiments relating to the present invention will be described in detail with reference to the accompanying drawings. The suffixes “module” and “unit” for components used in the description below are assigned or mixed in consideration of easiness in writing the specification and do not have distinctive meanings or roles by themselves.

Hereinafter, various embodiments of a road (or path) guidance service provided to a user by the above-described airport robot disposed at airport will be described.

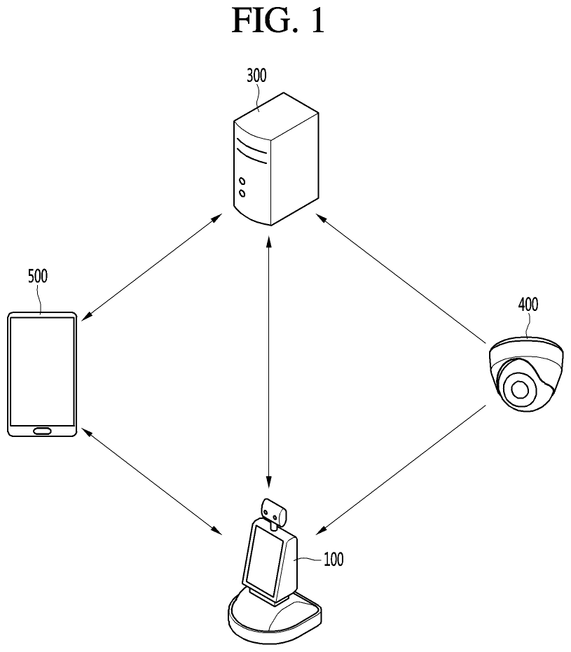

FIG. 1 is a diagram illustrating the structure of an airport robot system according to an embodiment of the present invention.

The airport robot system according to the embodiment of the present invention may include an airport robot 100, a server (or computing device) 300, a camera 400, and a mobile terminal 500.

The airport robot 100 may perform patrol, guidance, cleaning, disinfection and transportation within the airport.

The airport robot 100 may transmit and receive signals to and from the server 300 or the mobile terminal 500. For example, the airport robot 100 may transmit and receive signals including information on the situation of the airport to and from the server 300. In addition, the airport robot 100 may receive image information of the areas of the airport from the camera 400 in the airport. Accordingly, the airport robot 100 may monitor the situation of the airport through the image information captured by the airport robot 100 and the image information received from the camera 400.

The airport robot 100 may directly receive a command from the user. For example, a command may be directly received from the user through input of touching the display unit provided in the airport robot 100 or voice input. The airport robot 100 may perform patrol, guidance, cleaning, etc. according to the command received from the user, the server 300, or the mobile terminal 500.

Next, the server 300 may receive information from the airport robot 100, the camera 400, and/or the mobile terminal 500. The server 300 may collect, store and manage the information received from the devices. The server 300 may transmit the stored information to the airport robot 100 or the mobile terminal 500. In addition, the server 300 may transmit command signals to a plurality of the airport robots 100 disposed in the airport.

The camera 400 may include a camera installed in the airport. For example, the camera 400 may include a plurality of closed circuit television (CCTV) cameras installed in the airport, an infrared thermal-sensing camera, etc. The camera 400 may transmit the captured image to the server 300 or the airport robot 100.

The mobile terminal 500 may transmit and receive data to and from the server 300 in the airport. For example, the mobile terminal 500 may receive airport related data such as a flight time schedule, an airport map, etc. from the server 300. A user may receive necessary information of the airport from the server 300 through the mobile terminal 500. In addition, the mobile terminal 500 may transmit data such as a photo, a moving image, a message, etc. to the server 300. For example, the user may transmit the photograph of a missing child to the server 300 to report the missing child or photograph an area of the airport where cleaning is required through the camera to request cleaning of the area.

In addition, the mobile terminal 500 may transmit and receive data to and from the airport robot 100.

For example, the mobile terminal 500 may transmit, to the airport robot 100, a signal for calling the airport robot 100, a signal for instructing that specific operation is performed, or an information request signal. The airport robot 100 may move to the position of the mobile terminal 500 or perform operation corresponding to the instruction signal in response to the call signal received from the mobile terminal 500. Alternatively, the airport robot 100 may transmit data corresponding to the information request signal to the mobile terminal 500 of the user.

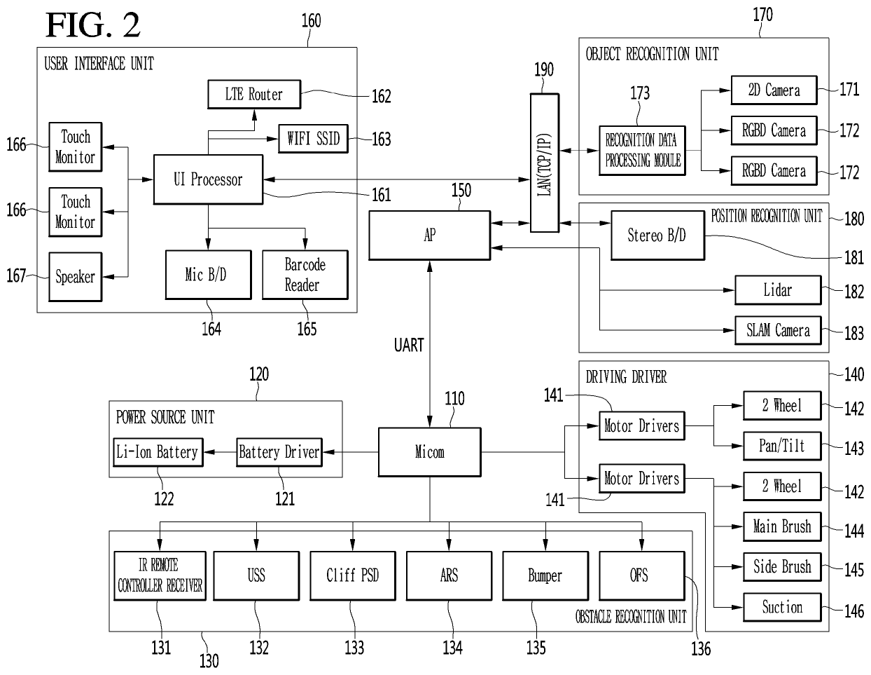

FIG. 2 is a block diagram illustrating a hardware configuration of an airport robot according to an embodiment of the present invention.

As illustrated in FIG. 2, hardware of the airport robot according to an embodiment of the present invention may be configured with a microcomputer group and an AP group. The microcomputer group may include a microcomputer 110, a power source unit 120, an obstacle recognition unit 130, and a driving driver 140. The AP group may include an AP 150, a user interface unit 160, an object recognition unit 170, a position recognition unit 180, and a local area network (LAN) 190.

The microcomputer 110 may manage the power source unit 120 including a battery of the hardware of the airport robot, the obstacle recognition unit 130 including various kinds of sensors, and the driving driver 140 including a plurality of motors and wheels.

The power source unit 120 may include a battery driver 121 and a lithium-ion (li-ion) battery 122. The battery driver 121 may manage charging and discharging of the li-ion battery 122. The li-ion battery 122 may supply power for driving the airport robot. The li-ion battery 122 may be configured by connecting two 24V/102A li-ion batteries in parallel.

The obstacle recognition unit 130 may include an infrared (IR) remote controller receiver 131, an ultrasonic sensor (USS) 132, a cliff PSD 133, an attitude reference system (ARS) 134, a bumper 135, and an optical flow sensor (OFS) 136. The IR remote controller receiver 131 may include a sensor which receives a signal from an IR remote controller for remotely controlling the airport robot. The USS 132 may include a sensor for determining a distance between an obstacle and the airport robot by using an ultrasonic signal. The cliff PSD 133 may include a sensor for sensing a precipice or a cliff within a forward-direction airport robot driving range of 360 degrees. The ARS 134 may include a sensor for detecting a gesture of the airport robot. The ARS 134 may include a sensor which is configured with an acceleration 3-axis and a gyro 3-axis for detecting the number of rotations. The bumper 135 may include a sensor which senses a collision between the airport robot and an obstacle. The sensor included in the bumper 135 may sense a collision between the airport robot and an obstacle within a 360-degree range. The OFS 136 may include a sensor for measuring a phenomenon where a wheel is spinning in driving of the airport robot and a driving distance of the airport robot on various floor surfaces.

The driving driver 140 may include a motor driver 141, a wheel motor 142, a rotation motor 143, a main brush motor 144, a side brush motor 145, and a suction motor 146. The motor driver 141 may perform a function of driving the wheel motor, the brush motor, and suction motor for driving and cleaning of the airport robot. The wheel motor 142 may drive a plurality of wheels for driving of the airport robot. The rotation motor 143 may be driven for a lateral rotation and a vertical rotation of a head unit of the airport robot or a main body of the airport robot, or may be driven the direction change or rotation of a wheel of the airport robot. The main brush motor 144 may drive a brush which sweeps filth on an airport floor. The side brush motor 145 may drive a brush which sweeps filth in a peripheral area of an outer surface of the airport robot. The suction motor 146 may be driven for sucking filth on the airport floor.

The AP 150 may function as a central processing unit which manages a whole hardware module system of the airport robot. The AP 150 may transmit, to the microcomputer 110, user input/output information and application program driving information for driving by using position information obtained through various sensors, thereby allowing a motor or the like to be performed.

The user interface unit 160 may include a user interface (UI) processor 161, a long term evolution (LTE) router 162, a WIFI SSID 163, a microphone board 164, a barcode reader 165, a touch monitor 166, and a speaker 167. The user interface processor 161 may control an operation of the user interface unit which performs an input/output of a user. The LTE router 162 may receive necessary information from the outside and may perform LTE communication for transmitting information to the user. The WIFI SSID 163 may analyze WIFI signal strength to perform position recognition on a specific object or the airport robot. The microphone board 164 may receive a plurality of microphone signals, process a sound signal into sound data which is a digital signal, and analyze a direction of the sound signal and a corresponding sound signal. The barcode reader 165 may read barcode information described in a plurality of targets used in airport. The touch monitor 166 may include a monitor for displaying output information and a touch panel which is configured for receiving the input of the user. The speaker 167 may inform the user of specific information through a voice.

The object recognition unit 170 may include a two-dimensional (2D) camera 171, a red, green, blue, and distance (RGBD) camera 172, and a recognition data processing module 173. The 2D camera 171 may be a sensor for recognizing a person or an object on the basis of a 2D image. The RGBD camera 172 may be a camera including RGBD sensors or may be a sensor for detecting a person or an object by using captured images including depth data obtained from other similar three-dimensional (3D) imaging devices. The recognition data processing module 173 may process a signal such as 2D image/video or 3D image/video obtained from the 2D camera and the RGBD camera 172 to recognize a person or an object.

The position recognition unit 180 may include a stereo board (B/D) 181, a light detection and ranging (LIDAR) 182, and a simultaneous localization and mapping (SLAM) camera 183. The SLAM camera 183 may implement simultaneous position tracing and mapping technology. The airport robot may detect ambient environment information by suing the SLAM camera 183 and may process obtained information to generate a map corresponding to a duty performing space and simultaneously estimate its absolute position. The LIDAR 182, a laser radar, may be a sensor which irradiates a laser beam and collects and analyzes rearward-scattered light of light absorbed or scattered by aerosol to perform position recognition. The stereo board 181 may process sensing data collected from the LIDAR 182 and the SLAM camera 183 to manage data for recognizing a position of the airport robot and an obstacle.

The LAN 190 may perform communication with the user interface processor 161 associated with a user input/output, the recognition data processing module 173, the stereo board 181, and the AP 150.

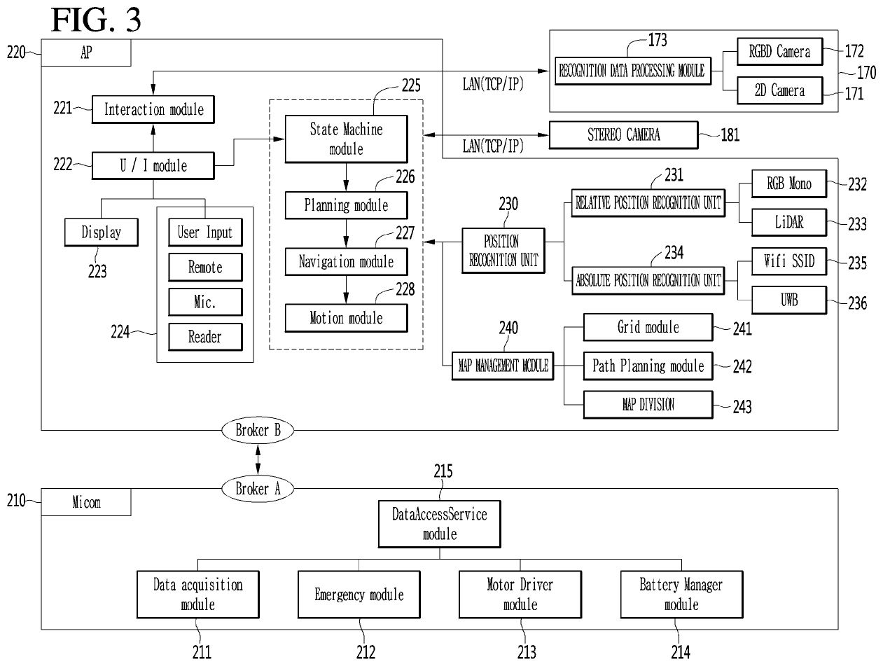

FIG. 3 is a diagram illustrating in detail a configuration of each of a microcomputer and an AP of an airport robot according to another embodiment of the present invention.

As illustrated in FIG. 3, a microcomputer 210 and an AP 220 may be implemented as various embodiments, for controlling recognition and action of the airport.

For example, the microcomputer 210 may include a data access service module 215. The data access service module 215 may include a data acquisition module 211, an emergency module 212, a motor driver module 213, and a battery manager module 214. The data acquisition module 211 may acquire data sensed from a plurality of sensors included in the airport robot and may transfer the acquired data to the data access service module 215. The emergency module 212 may be a module for sensing an abnormal state of the airport robot, and when the airport robot performs a predetermined type action, the emergency module 212 may sense that the airport robot is in the abnormal state. The motor driver module 213 may manage a wheel, a brush, and driving control of a suction motor for driving and cleaning of the airport robot. The battery manager module 214 may manage charging and discharging of the li-ion battery 122 of FIG. 2 and may transfer a battery state of the airport robot to the data access service module 215.

The AP 220 may receive, recognize, and process a user input and the like to control an operation of the airport robot with various cameras and sensors. An interaction module 221 may be a module which synthesizes recognition data received from the recognition data processing module 173 and a user input received from a user interface module 222 to manage software exchanged between a user and the airport robot. The user interface module 222 may receive a close-distance command of the user such as a key, a touch screen, a reader, and a display unit 223 which is a monitor for providing manipulation/information and a current situation of the airport robot, or may receive a long-distance signal such as a signal of an IR remote controller for remotely controlling the airport robot, or may manage a user input received of a user input unit 224 receiving an input signal of the user from a microphone, a barcode reader, or the like. When one or more user inputs are received, the user interface module 222 may transfer user input information to a state machine module 225. The state machine module 225 which has received the user input information may manage a whole state of the airport robot and may issue an appropriate command corresponding to a user input. A planning module 226 may determine a start time and an end time/action for a specific operation of the airport robot according to the command transferred from the state machine module 225 and may calculate a path through which the airport will move. A navigation module 227 may be a module which manages overall driving of the airport robot and may allow the airport robot to drive along a driving path calculated by the planning module 226. A motion module 228 may allow the airport robot to perform a basic operation in addition to driving.

Moreover, the airport robot according to another embodiment of the present invention may include a position recognition unit 230. The position recognition unit 230 may include a relative position recognition unit 231 and an absolute position recognition unit 234. The relative position recognition unit 231 may correct a movement amount of the airport robot through an RGM mono sensor 232, calculate a movement amount of the airport robot for a certain time, and recognize an ambient environment of the airport robot through a LIDAR 233. The absolute position recognition unit 234 may include a WIFI SSID 235 and a UWB 236. The WIFI SSID 235 may be an UWB sensor module for recognizing an absolute position of the airport robot and may be a WIFI module for estimating a current position through WIFI SSID sensing. The WIFI SSID 235 may analyze WIFI signal strength to recognize a position of the airport robot. The UWB 236 may calculate a distance between a transmission unit and a reception unit to sense the absolute position of the airport robot.

Moreover, the airport robot according to another embodiment of the present invention may include a map management module 240. The map management module 240 may include a grid module 241, a path planning module 242, and a map division module 243. The grid module 241 may manage a lattice type map generated by the airport robot through an SLAM camera or map data of an ambient environment, previously input to the airport robot, for position recognition. In map division for cooperation between a plurality of airport robots, the path planning module 242 may calculate driving paths of the airport robots. Also, the path planning module 242 may calculate a driving path through which the airport robot will move. Also, the path planning module 242 may calculate a driving path through which the airport robot will move in an environment where one airport robot operates. The map division module 243 may calculate in real time an area which is to be managed by each of a plurality of airport robots.

Pieces of data sensed and calculated from the position recognition unit 230 and the map management module 240 may be again transferred to the state machine module 225. The state machine module 225 may issue a command to the planning module 226 so as to control an operation of the airport robot, based on the pieces of data sensed and calculated from the position recognition unit 230 and the map management module 240.

Hereinafter, various embodiments of a route guidance service provided to a user by the airport robot provided in the airport will be described.

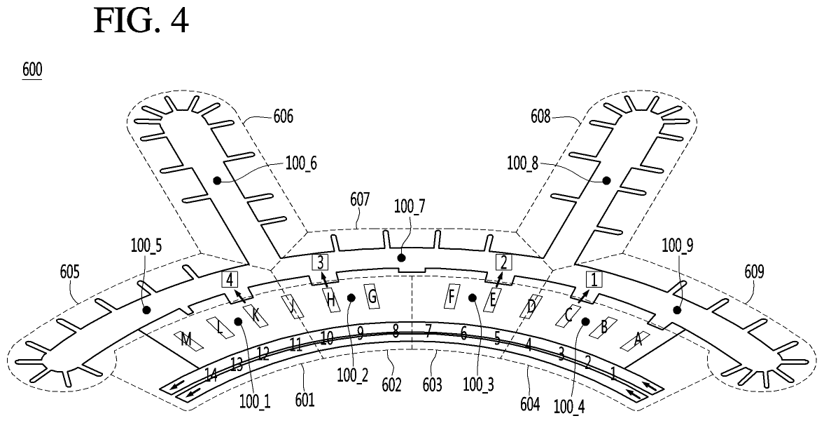

FIG. 4 is a diagram illustrating an example where a plurality of airport robots according to an embodiment of the present invention are respectively disposed in a plurality of regions of airport to provide a service.

Referring to FIG. 4, a plurality of airport robots 100_1 to 100_9 may be disposed at airport 600. Each of the plurality of airport robots 100_1 to 100_9 may provide various services such as guidance, patrol, cleaning, or a military service, but in the present specification, it is assumed that each of the plurality of airport robots 100_1 to 100_9 provides a road guidance service.

According to an embodiment of the present invention, in order to more efficiently provide a service by using the plurality of airport robots 100_1 to 100_9, the plurality of airport robots 100_1 to 100_9 may be distributed to and disposed in regions of the airport 600.

As illustrated in FIG. 4, in a case where the airport 600 is divided into first to ninth regions 601 to 609, each of the plurality of airport robots 100_1 to 100_9 may be disposed in one region. In detail, a server 300 may perform an operation of dividing the airport 600 into a plurality of regions 601 to 609 and may perform an operation of placing at least one airport robot 100 in each of divided regions. In FIG. 4, one airport robot is illustrated as being disposed in each of the regions 601 to 609, but according to an embodiment, two or more airport robots may be disposed in a specific region.

According to an embodiment, the server 300 may change regions at every certain time, based on various information (for example, a flight schedule, a region-based user density, etc.) about the airport 600.

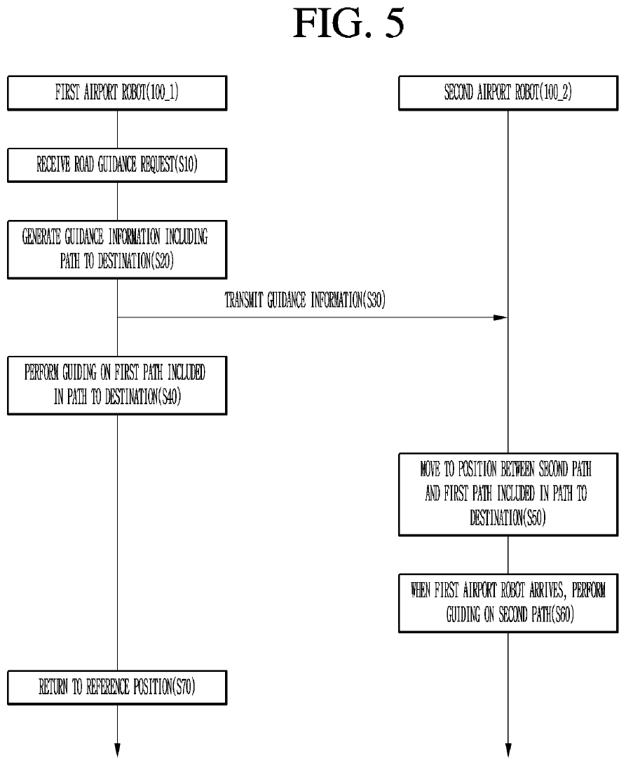

Each of the plurality of airport robots 100_1 to 100_9 may provide the road guidance service while moving in a disposed region. For example, a first airport robot 100_1 disposed in the first region 601 may move in only the first region 601 and may provide the road guidance service. That is, when a destination of a service user is in the first region 601, the first airport robot 100_1 may guide the service user to the destination. On the other hand, when the destination is not in the first region 601, the first airport robot 100_1 may perform guidance up to a path, included in the first region 601, of paths to the destination. Other airport robots may perform guidance through the other paths. This will be described below in detail with reference to FIGS. 5 to 13.

FIG. 5 is a ladder diagram for describing a road guidance service providing method of an airport robots according to an embodiment of the present invention.

Referring to FIG. 5, one (for example, the first airport robot 100_1) of the plurality of airport robots 100_1 to 100_9 disposed at the airport 600 may receive a road guidance request from a user (S10).

The first airport robot 1001 may stand by at a specific position of the first region 601, or may freely use the first region 601. When the user desires to get the road guidance service, the user may request the road guidance service through a touch input, a voice input, or the like using a user interface 160 (for example, the touch monitor 166, the microphone 164, or the like) of the first airport robot 100_1. According to an embodiment, the user may request the road guidance service based on the first airport robot 100_1 by using the mobile terminal 500. In order to get the road guidance service, the user may input a road guidance request including destination information through the touch input, the voice input, or the mobile terminal 500.

In other words, the first airport robot 100_1 may receive a voice type road guidance request through the microphone 164, or may receive a touch input type road guidance request through the touch monitor 166. Also, the first airport robot 100_1 may receive a road guidance request from the mobile terminal 500 of the user through a communication unit (for example, the LTE router 162). That is, the above-described microphone 164, touch monitor 166, and communication unit may be configured as a reception unit for receiving the road guidance request.

The first airport robot 1001 may generate guidance information including a path to a destination in response to the received road guidance request (S20).

An AP 150 (hereinafter referred to as a controller) of the first airport robot 100_1 may set a path to a destination, based on destination information included in the received road guidance request. The controller 150 may generate guidance information including the set path.

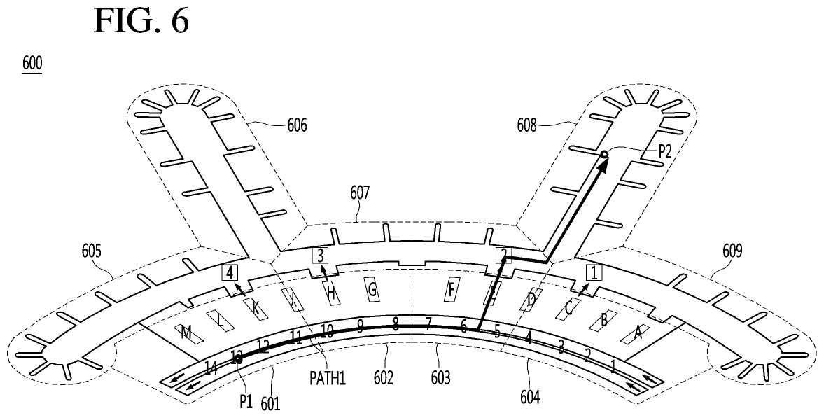

For example, the controller 150 may set a path from a current position to a destination, based on map information about the airport 600 stored in a memory (not shown) of the first airport robot 100_1 or received from the server 300. According to an embodiment, the controller 150 may set the path to the destination on the basis of a state of each of airport robots at the airport 600, or may set the path to the destination on the basis of a state of regions of the airport 600. Various embodiments where the controller 150 sets a path to a destination will be described in more detail with reference to FIGS. 6 to 10.

FIG. 6 is a diagram for describing for describing an embodiment of an operation of setting, by an airport robot, a path to a destination.

Referring to FIG. 6, the first airport robot 100_1 disposed in the first region 601 may receive a road guidance request from a user. For example, the user may input the road guidance request including information about a destination P2 through a display unit 223 (or a touch monitor 166) or a microphone of the first airport robot 100_1 or other user input unit. In response to the received road guidance request, the controller 150 of the first airport robot 100_1 may set a path PATH1 from a current position P1 to a destination P2 and may generate guidance information including the set path PATH1. The controller 150 may set the path PATH1, based on map information received from a memory (not shown) or the server 300.

According to the illustration of FIG. 6, the path PATH1 may be provided in the first region 601, the second region 602, the third region 603, the seventh region 607, and the eighth region 608.

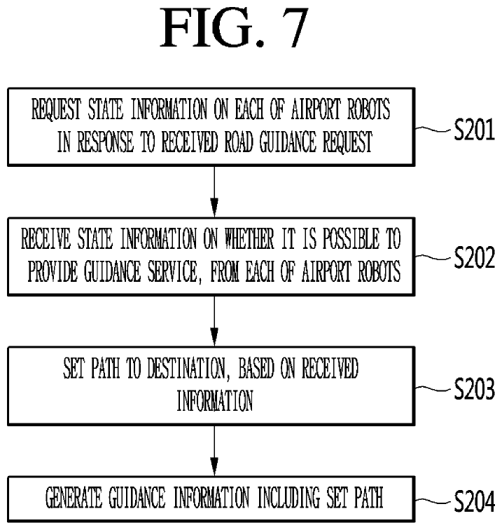

FIG. 7 is a flowchart for describing another embodiment of an operation of setting, by an airport robot, a path to a destination.

Referring to FIG. 7, an airport robot (for example, the first airport robot 100_1) may request state information about each of airport robots (for example, the second to ninth airport robots 100_2 to 100_9) in response to a received road guidance request (S201).

The state information is information associated with whether the airport robot 100 is capable of currently providing a road guidance service, and particularly, may include a current operating state of the airport robot 100. The current operating state of the airport robot 100 may include a standby state, a guidance state, and a charging state, but is not limited thereto.

The first airport robot 1001 may receive state information, associated with whether the road guidance service is capable of being provided, from each of the airport robots 100_2 to 100_9 (S202) and may set a path to a destination on the basis of the received information (S203). The first airport robot 100_1 may generate guidance information including the set path (S204).

The controller 150 of the first airport robot 100_1 may determine whether each of the airport robots 100_2 to 100_9 is capable of currently providing the road guidance service, based on the state information received from each of the airport robots 100_2 to 100_9. For example, when a state of the second airport robot 1002 is the guidance state or the charging state, the controller 150 may determine that the second airport robot 100_2 is incapable of providing the road guidance service. On the other hand, when a state of the fifth airport robot 100_5 is the standby state, the controller 150 may determine that the fifth airport robot 100_5 is capable of providing the road guidance service.

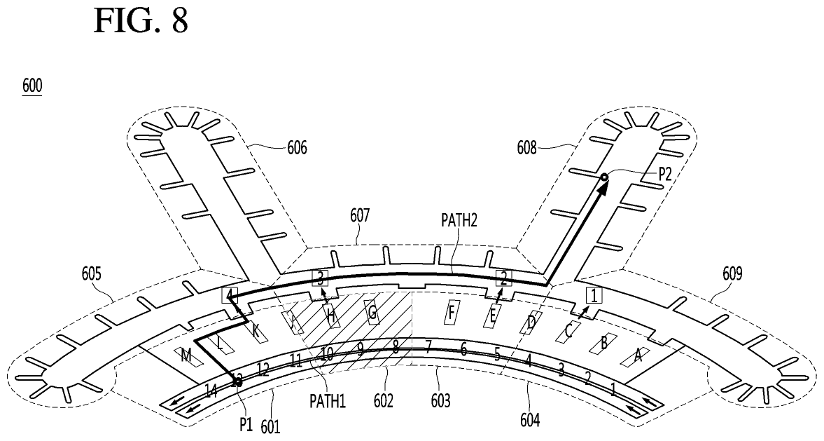

The controller 150 may set a path to a destination, based on a result of the determination. In this case, the set path may be provided to pass through only regions where airport robots determined as capable of providing the road guidance service are disposed. This will be described with reference to FIG. 8.

FIG. 8 is an exemplary diagram of a path to a destination set according to an embodiment illustrated in FIG. 7.

Referring to FIG. 8, the first airport robot 100_1 may set a path PATH2 from a current position P1 to a destination P2, based on a state of each of the airport robots 100_2 to 100_9. For example, when a state of the second airport robot 100_2 disposed in the second region 602 is the guidance state, the controller 150 of the first airport robot 100_1 may determine that the second airport robot 100_2 is incapable of providing the road guidance service. Based on a result of the determination, unlike the path PATH1 illustrated in FIG. 6, the controller 150 may set the path PATH2 which is provided in the first region 601, the fifth region 605, the seventh region 607, and the eighth region 608.

That is, the first airport robot 100_1 may set a path which is provided in regions where airport robots capable of providing the road guidance service are disposed, based on the state of each of the airport robots 100_2 to 100_9.

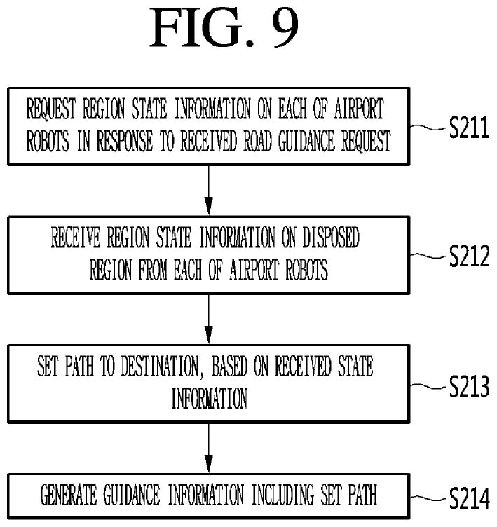

FIG. 9 is a flowchart for describing for describing another embodiment of an operation of setting, by an airport robot, a path to a destination.

Referring to FIG. 9, the first airport robot 100_1 may request state information about a region where each of airport robots is disposed, in response to a received road guidance request (S211).

The state information about the region may include a degree of congestion based on the number or density of users in a corresponding region and the limitation or not of region passage based on the occurrence of an emergency situation or an abnormal situation. That is, the state information may denote information about whether movement in a corresponding region is smooth.

The first airport robot 100_1 may receive region state information about a region where each of the airport robots 100_2 to 100_9 is disposed, from each of the airport robots 100_2 to 100_9 (S212). Based on the received region state information, the first airport robot 100_1 may set a path to a destination (S213) and may generate guidance information including the set path (S214).

The controller 150 of the first airport robot 100_1 may determine it is possible to pass through each region when moving to the destination, based on the region state information received from each of the airport robots 100_2 to 100_9. For example, when a region state of the seventh region 607 received from the seventh airport robot 100_7 is a congestion state (i.e., when a degree of congestion is higher than a reference value), the controller 150 may determine that it is unable to pass through the seventh region 607. On the other hand, when a region state of the ninth region 609 received from the ninth airport robot 100_9 is a non-congestion state (i.e., when a degree of congestion is lower than the reference value), the controller 150 may determine that it is unable to pass through the ninth region 609.

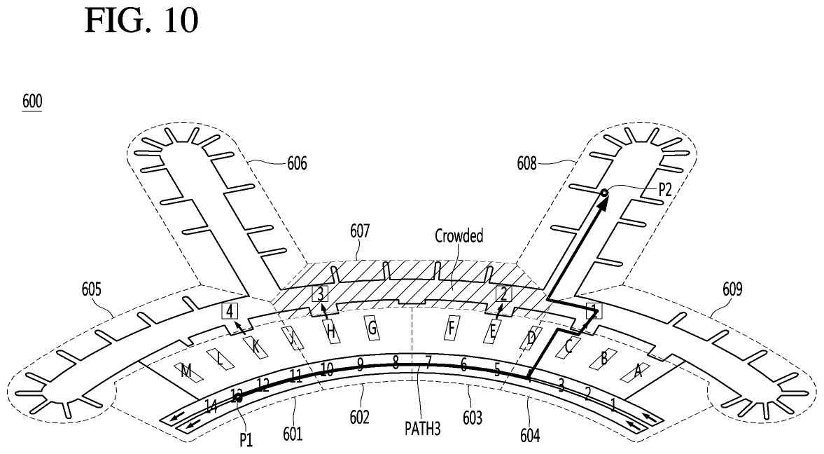

The controller 150 may set a path to a destination, based on a result of the determination. In this case, the set path may be provided so that a user using the road guidance service passes through only regions through which the user is capable of smoothly passing, thereby enhancing convenience of the user. This will be described with reference to FIG. 10.

FIG. 10 is an exemplary diagram of a path to a destination set according to an embodiment illustrated in FIG. 9.

Referring to FIG. 10, the first airport robot 100_1 may set a path PATH3 from a current position P1 to a destination P2, based on a state of each of the regions where the airport robots 100_2 to 100_9 are respectively disposed. For example, when a state of the seventh region 607 received from the seventh airport robot 100_7 is a congestion state, the controller 150 may determine as incapable of passing through the second region 607. Based on a result of the determination, unlike the path PATH1 illustrated in FIG. 6, the controller 150 may set the path PATH3 which is provided in the first region 601, the second region 602, the third region 603, the fourth region 604, the ninth region 609, and the eighth region 608.

That is, the first airport robot 100_1 may set a path provided in regions which enable a user to smoothly pass therethrough, based on a region state received from each of the airport robots 100_2 to 100_9 respectively disposed in the regions 602 to 609.

FIG. 5 will be described again.

The first airport robot 100_1 may transmit guidance information, including a path to a destination, to other airport robots (for example, the second airport robot 1002) (S30).

For example, the controller 150 of the first airport robot 100_1 may transmit the generated guidance information to each of airport robots disposed in regions including at least a portion of the path among a plurality of airport robots disposed at the airport 600. According to an embodiment, the controller 150 may transmit the guidance information to each of airport robots disposed in regions which do not include the path.

The first airport robot 100_1 may perform a road guidance operation on a first path included in the path to the destination (S40).

In detail, the first airport robot 100_1 may perform the road guidance operation on the first path provided in a first region, where the first airport robot 100_1 is disposed, of the path to the destination. The first airport robot 100_1 may move along the first path to perform the road guidance operation. The first airport robot 100_1 may periodically check, by using the object recognition unit 170 or the like, whether a user follows the first airport robot 100_1 while moving. When it is checked that the user follows the first airport robot 100_1, the first airport robot 100_1 may continually move along the first path. The first airport robot 100_1 may output, through the display unit 223 or the speaker 167, notification or a message for allowing the user to follow the first airport robot 100_1.

While the first airport robot 100_1 is performing road guidance, the second airport robot 1002 disposed in a second region adjacent to the first region may move to a position between the first path and the second path for performing a road guidance operation on the second path provided in the second region (S50).

The second airport robot 1002 may move to a start position (i.e., a position between the first path and the second path) of the second path, for performing a road guidance operation on the second path, included in the region, of the path to the destination. According to an embodiment, the first airport robot 100_1 may transmit information about an arrival estimation time to the second airport robot 1002, and the second airport robot 100_2 may move to a start position of the second path, based on the arrival estimation time of the first airport robot 100_1.

When a guidance operation performed on the first path is completed as the first airport robot 100_1 arrives at a position to which the second airport robot 100_2 has moved, the second airport robot 1002 may perform a guidance operation on the second path (S60).

A guidance operation performed on the second path of the second airport robot 100_2 is similar to a guidance operation performed on the first path of the first airport robot 100_1. Therefore, after the user gets a road guidance service corresponding to the first path from the first airport robot 100_1, the user may be provided with a road guidance service corresponding to the second path from the second airport robot 100_2.

The first airport robot 100_1 may complete the guidance operation performed on the first path, and then, may return to a reference position (S70). According to an embodiment, the first airport robot 100_1 may induce the use of another user while freely moving in the first region.

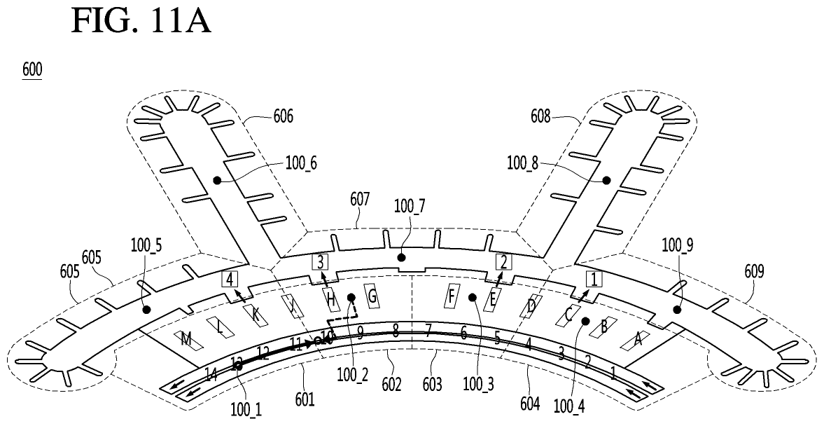

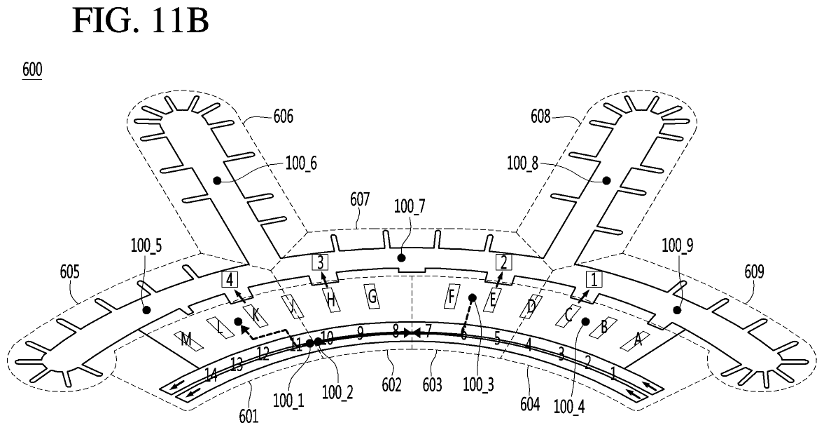

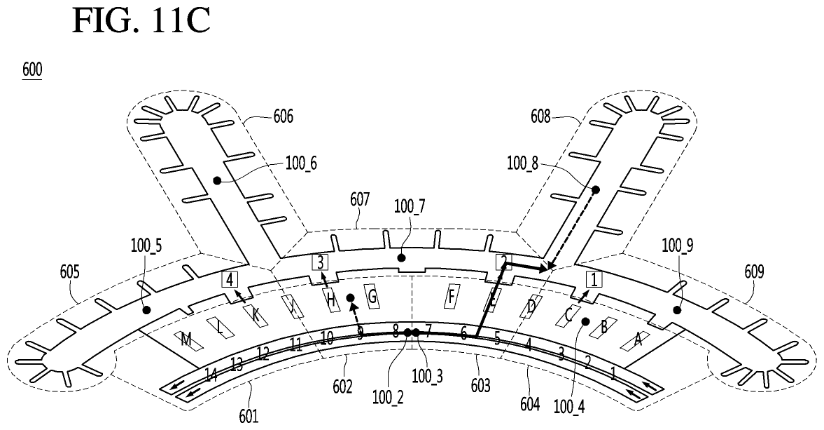

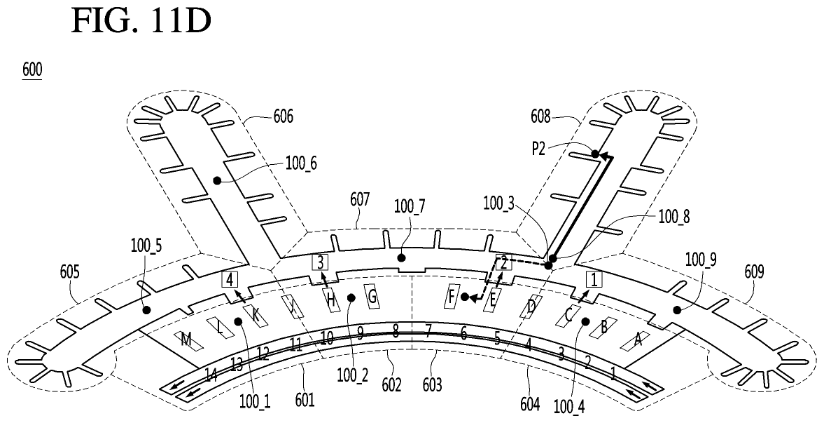

Based on the road guidance service providing method of a plurality of airport robots described above with reference to FIG. 5, an operation of guiding, by the plurality of airport robots, a user to a destination will be described in detail with reference to FIGS. 11A to 11D.

FIGS. 11A to 11D are diagrams illustrating an operation of guiding, by a plurality of airport robots according to an embodiment of the present invention, a user to a destination.

In FIGS. 11A to 11D, an example where a plurality of airport robots guide a user to a destination through the path PATH1 illustrated in FIG. 4 will be described. That is, the path PATH1 may be provided in the first region 601, the second region 602, the third region 603, the seventh region 607, and the eighth region 608. In this case, the first airport robot 100_1, the second airport robot 1002, the third airport robot 100_3, the seventh airport robot 100_7, and the eighth airport robot 100_8 may provide a user with a road guidance service.

Referring to FIGS. 11A to 11D, the first airport robot 100_1 may perform a road guidance operation on a first path, included in the first region 601, of the path PATH1. The first airport robot 100_1 may perform the road guidance operation on the first path while moving along the first path from a start position P1.

The second airport robot 1002 disposed in the second region 602 including a second path corresponding to a path next to the first path may move to a start position (i.e., a position between the first path and the second path) of the second path, for performing a road guidance operation on the second path. The second airport robot 100_2 may previously move to the position and may wait for arrival of the first airport robot 100_1 or may move to the position according to an estimation arrival time of the first airport robot 100_1.

Referring to FIG. 11B, when the first airport robot 100_1 completes the road guidance operation performed on the first path, the second airport robot 100_2 may provide a user with a road guidance service corresponding to the second path. That is, the second airport robot 100_2 may move along the second path, and the user may follow the second airport robot 100_2.

The first airport robot 100_1 which has completed the road guidance operation performed on the first path may provide another user with a road guidance service while moving to a reference position or moving to an arbitrary position of the first region 601.

While the second airport robot 100_2 is performing a road guidance operation on the second path, the third airport robot 100_3 disposed in the third region 603 including a third path corresponding to a path next to the second path may move to a start position (i.e., a position between the first path and the third path) of the third path.

Referring to FIG. 11C, when the second airport robot 1002 completes the road guidance operation performed on the second path, the third airport robot 100_3 may provide a user with a road guidance service corresponding to the third path. That is, the third airport robot 100_3 may move along the third path, and the user may follow the third airport robot 100_3.

The second airport robot 100_2 which has completed the road guidance operation performed on the second path may provide another user with a road guidance service while moving to the reference position or moving to an arbitrary position of the second region 602.

While the third airport robot 100_3 is performing a road guidance operation on the third path, the seventh airport robot 100_7 disposed in the seventh region 607 including a fourth path corresponding to a path next to the third path may move to a start position (i.e., a position between the third path and the fourth path) of the fourth path.

According to an embodiment, while one of the first to third airport robots 100_1 to 100_3 is performing a road guidance operation, the seventh airport robot 100_7 may also receive a road guidance request from another user. In this case, since the seventh airport robot 100_7 should provide the road guidance service to the other user, the seventh airport robot 100_7 may not provide a road guidance service corresponding to the fourth path of the path PATH1 of a previous user. Accordingly, the seventh airport robot 100_7 may transmit, to the third airport robot 100_3, information representing a state where it is unable to provide the road guidance service corresponding to the fourth path.

The third airport robot 100_3 which has received the information may perform the road guidance service corresponding to the third path, and then, may also perform a road guidance operation on the fourth path included in the seventh region 607.

While the third airport robot 100_3 is performing a road guidance operation on the third path and the fourth path, the eighth airport robot 100_8 disposed in the eighth region 608 including a fifth path corresponding to a path next to the fourth path may move to a start position (i.e., a position between the fourth path and the fifth path) of the fifth path.

Referring to FIG. 11D, when the third airport robot 100_3 completes the road guidance operation performed on the third path and the fourth path, the eighth airport robot 100_8 may provide a user with a road guidance service corresponding to the fifth path. That is, the eighth airport robot 100_8 may move to the destination P2 along the fifth path, and the user may arrive at the destination P2 by following the eighth airport robot 100_8.

The third airport robot 100_3 which has completed the road guidance operation performed on the third path and the fourth path may provide another user with a road guidance service while moving to an arbitrary position of the third region 603.

That is, according to an embodiment illustrated in FIGS. 11A to 11D, the airport robot system may provide a user with a road guidance service by using a plurality of airport robots. Particularly, each of the plurality of airport robots may not move a whole path to a destination but may perform only a road guidance operation on a path included in a disposed region, thereby providing a more efficient road guidance service. Also, according to an embodiment illustrated in FIGS. 11A to 11D, the plurality of airport robots may be continually distributed to and disposed in regions of airport, thereby preventing the airport robots from concentrating on a specific region in providing a road guidance service.

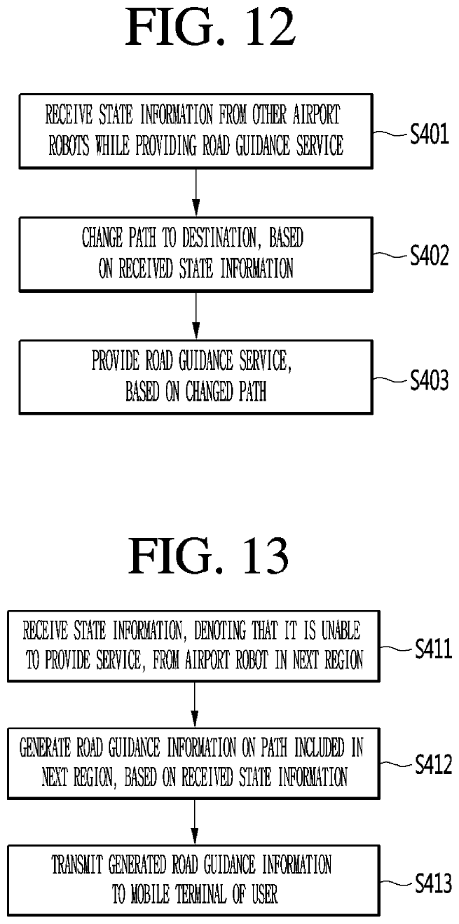

FIG. 12 is a flowchart for describing an operation of changing, by an airport robot according to an embodiment of the present invention, a path to a destination on the basis of a state of another airport robot.

A specific airport robot may set a path to a destination according to a road guidance request of a user, and while the specific airport robot is providing a road guidance service on the basis of the set path, a situation where a state of another airport robot is changed may occur. For example, when another airport robot receives a road guidance request from another user while standing by, the other airport robot may no longer provide a road guidance service which is to be provided to a previous user. In this case, the airport robot according to an embodiment of the present invention may actively change a path to a destination on the basis of a state change of the other airport robot.

In this context, referring to FIG. 12, the airport robot 100 may receive state information from other airport robots in the middle of providing a road guidance service (S401). That is, the airport robot 100 may receive the state information from the other airport robots even when the road guidance service is being provided to a user. For example, the state information may be periodically received, or may be received from an airport robot of which a state is changed when a state of a specific airport robot is changed in the middle of providing the road guidance service.

The airport robot 100 may change a path to a destination on the basis of the received state information (S402) and may provide the road guidance service on the basis of the changed path (S403).

For example, referring to the embodiments illustrated in FIGS. 6 and 10, the third airport robot 100_3 may receive state information from the seventh airport robot 100_7 while performing a road guidance service corresponding to the third path, included in the third region 603, of the path PATH1 to the destination. When the received state of the seventh airport robot 100_7 is changed from a standby state to a guidance state or a charging state, the third airport robot 100_3 may determine that the seventh airport robot 100_7 cannot provide a road guidance service. Based on a result of the determination, the third airport robot 100_3 may change a currently set path PATH1 to a path (for example, the path PATH3 of FIG. 10) which does not pass through the seventh region 607.

The third airport robot 100_3 may perform a road guidance operation on the changed third path, based on the changed path PATH3. Subsequently, the fourth airport robot 100_4 may perform a road guidance operation on the fourth path included in the fourth region 604, and the ninth airport robot 100_9 may perform a road guidance operation on the fifth path included in the ninth region 609. Finally, the eighth airport robot 100_8 may perform a road guidance operation on the sixth path included in the eighth region 608 to guide a user to the destination P2.

That is, according to an embodiment illustrated in FIG. 12, the airport robot 100 may actively change a path to a destination on the basis of a state change of another airport robot in the middle of performing a road guidance operation. Accordingly, a smooth road guidance service may be provided to a user.

FIG. 13 is a flowchart for describing an operation of providing, by an airport robot according to an embodiment of the present invention, road guidance information to a mobile terminal of a user when it is unable for an airport robot of a next region to provide a service.

In a case of providing a road guidance service by units of regions by using a plurality of airport robots as in an embodiment of the present invention, a situation where an airport robot in a specific region cannot provide a road guidance service may occur. Accordingly, a problem where a road guidance service corresponding to a path included in a corresponding region cannot be provided by using an airport robot may occur, and a user may be confused.

In a method for solving the problem, referring to an embodiment illustrated in FIG. 13, the airport robot 100 may receive state information, denoting that it is unable to provide a service, from an airport robot in a next region (S411). For example, when a state of an airport robot in a next region is changed from a standby state to a guidance state or a charging state, the airport robot in the next region may not provide a road guidance service corresponding to a path included in a corresponding region.

The airport robot 100 may generate road guidance information about a path included in a next region on the basis of received state information about an airport robot in the next region (S412) and may transmit the generated road guidance information to the mobile terminal 500 of the user (S413).

The road guidance information may include information about a path included in the next region. The mobile terminal 500 may output the received road guidance information through a display unit or a sound output unit, thereby guiding a service user to move along a path included in the next region.

The service user may complete movement based on the path included in the next region on the basis of the road guidance information output through the mobile terminal 500. In this case, the user may be provided with a road guidance service from an airport robot in the next region.

That is, according to an embodiment illustrated in FIG. 13, when there is a region where an airport robot cannot provide a road guidance service, the airport robot may transmit road guidance information about a corresponding region to a mobile terminal of a user, thereby allowing the user to move along a path. Accordingly, a service user may be continually provided with a road guidance service corresponding to a path to a destination.

The embodiments illustrated in FIGS. 5 to 13 are illustrated as being performed by only an airport robot, but may be performed by the server 300 connected to each of airport robots. In this case, the server 300 may perform an operation of setting or changing a path to a destination and may transmit information about the set or changed path to each of the airport robots, thereby providing a road guidance service.

According to an embodiment of the present invention, the above-mentioned method can be embodied as computer readable codes on a non-transitory computer readable recording medium having a program thereon. Examples of the computer readable recording medium include ROM, RAM, CD-ROM, magnetic tape, floppy disk, and an optical data storage device. Also, the computer can include an AP 150 of the robot for airport. The above-described display device is not limited to the application of the configurations and methods of the above-described embodiments and the entire or part of the embodiments can be selectively combined and configured to allow various modifications.

1. A robot to provide a path guidance service, the robot comprising:
a motor configured to generate a force to move the robot;
a user interface configured to receive a path guidance request from a user; and
a controller configured to:
set paths to a destination based on destination information included in the received path guidance request,
generate guidance information based on the set path,
transmit data associated with the generated guidance information to one or more other robots, and
perform a path guidance operation corresponding to at least one path of the set paths,
wherein the at least one path is provided in a region where the robot is positioned.

2. The robot of claim 1, wherein:
the controller receives, from at least one of the one or more other robots, state information indicating whether a path guidance service corresponding to the path guidance request can be provided, and sets the paths based on the received state information, and
the set paths pass through at least one region, of a plurality of regions, where at least one of the other robots capable of providing the path guidance service is positioned.

3. The robot of claim 1, wherein the controller is further configured to:
receive, while performing the path guidance operation on the at least one path of the set paths, state information from at least one of the other robots, and
change one or more of the set paths based on the received state information.

4. The robot of claim 1, wherein the controller is further configured to:
receive, while performing the path guidance operation on the at least one path of the set paths, state information, the state information indicating that another robot is unable to provide a service, the other robot being positioned in a region including another path of the set paths,
generate path guidance information on the other path of the set paths based on the received state information, and
transmit the generated path guidance information to a mobile terminal of the user.

5. The robot of claim 1, wherein:
the controller receives region state information associated with whether regions where the other robots are positioned are passable, and sets the paths based on the received region state information, and
the controller sets the paths to pass through only ones of the regions which are passable.

6. The robot of claim 5, wherein the controller:
determines whether the user can pass through each of the plurality of regions based on data in region state information identifying degrees of congestion in each of the regions,
determines a first region, of the regions, having a degree of congestion that is higher than a reference value, as a passage-enabled region, and
determines a second region, of the regions, having a degree of congestion that is lower than the reference value, as a passage-disabled region,
wherein the set paths include the passage-enabled region and excludes the passage-disabled region.

7. The robot of claim 1, wherein the controller, when transmitting the data associated with the generated guidance information to the one or more other robots, transmits the generated guidance information to robots positioned in regions included in the set paths.

8. The robot of claim 1, wherein the controller controls the motor to move the robot along the at least one path of the set paths when performing the path guidance operation on the at least one path.

9. The robot of claim 1, wherein, when performing the path guidance operation on the at least one path of the set paths is completed, the controller controls the motor to move the robot to a reference position.

10. The robot of claim 1, wherein the user interface includes at least one of a microphone configured to receive audio associated with the path guidance request, a touch monitor configured to receive a touch input associated with the path guidance request, or a communication interface configured to receive the path guidance request from a mobile terminal of the user.

11. A robot system comprising:
a first robot positioned in a first region of a plurality of regions; and
a second robot positioned in a second region adjacent to the first region,
wherein
the first robot receives a path guidance request from a user, sets paths to a destination based on destination information included in the received path guidance request, transmits guidance information including the set paths to the second robot, and performs a path guidance operation on a first path, included in the first region, of the set paths, and
the second robot receives the guidance information from the first robot and performs a path guidance operation on a second path, included in the second region, of the set paths.

12. The robot system of claim 11, wherein
the second robot moves to a start position of the second path while the first robot is performing the path guidance operation on the first path, and
when the first robot completes the path guidance operation on the first path, the second robot performs the path guidance operation on the second path from the start position.

13. The robot system of claim 12, wherein, when the first robot completes the path guidance operation on the first path, the first robot moves to a reference position.

14. The robot system of claim 11, wherein
the first robot receives state information indicating whether a path guidance service corresponding to the path guidance request can be provided by the second robot and robots positioned at a plurality of regions and sets the paths based on the received state information, and
the set paths pass through only ones of the regions where ones of the robots capable of providing the path guidance service are positioned.

15. The robot system of claim 14, wherein, when the path guidance operation is being performed on the first path and a state of the second robot changes such that the second robot is incapable of providing the path guidance service in the second path, the first robot changes the set paths to exclude the second path and to not pass through the second region, and performs the path guidance operation based on the changed set paths.

16. The robot system of claim 14, wherein, when the path guidance operation is being performed on the first path and a state of the second robot is changed such that the second robot is incapable of providing the path guidance service on the second path, the first robot generates path guidance information about the second path, included in the second region associated with the second robot, and transmits the generated path guidance information to a mobile terminal of the user.

17. The robot system of claim 11, wherein
the first robot receives, from robots, region state information associated with whether the user can pass through regions where the robots are positioned and sets the paths based on the received region state information, and
the paths are set to pass through only one of the regions determined to be passible by the user.

18. The robot system of claim 17, wherein, based on the received region state information, the first robot determines a first region, of the regions, where a degree of congestion is higher than a reference value, as a passage-enabled region, determines a second region, of the regions, where the degree of congestion is lower than the reference value, as a passage-disabled region, and sets the paths to include the passage-enabled region and to exclude the passage-disabled region.

19. The robot system of claim 11, further comprising a computing device connected to each of the first robot and the second robot,
wherein the computing device receives the path guidance request from the first robot, determines the paths based on the destination information included in the received path guidance request, and transmits guidance information identifying the set paths to the first robot and the second robot.

20. The robot system of claim 11, wherein the first robot includes at least one of a microphone configured to receive audio associated the path guidance request, a touch monitor configured to receive a touch input associated with the path guidance request, or a communication interface configured to receive the path guidance request from a mobile terminal of the user.
